(19) United States
(12) Patent Application Publication
(10) Pub. No.: US 2024/0152144 A1
(43) Pub. Date: May 9, 2024

(54) SYSTEMS AND METHODS FOR LEARNING NEURAL NETWORKS FOR EMBEDDED APPLICATIONS

(71) Applicants: Continental Automotive Technologies GmbH, Hannover (DE); Nanyang Technological University, Singapore (SG)

(72) Inventors: Vincent Ribli, Singapore (SG); Shen Ren, Singapore (SG); Sinno Jialin Pan, Singapore (SG)

(73) Assignees: Continental Automotive Technologies GmbH, Hannover (DE); Nanyang Technological University, Singapore (SG)

(21) Appl. No.: 18/489,754

(22) Filed: Oct. 18, 2023

(30) Foreign Application Priority Data
Oct. 20, 2022 (GB) 2215479.3

(51) Int. Cl. G05D 1/00; G06N 3/02

(52) U.S. Cl. CPC G05D 1/0088; G06N 3/02

(57) ABSTRACT

The present disclosure relates to computer-implemented methods for automatically controlling a machine includes: receiving data generated using at least one sensor of a machine; performing one or more prediction tasks on the data using a neural network, wherein the neural network includes at least one parameter tensor having at least one element, and the at least one parameter tensor was over-parameterized during training into a plurality of component tensors; and controlling the machine based on results of the one or more prediction tasks. The present disclosure further relates to a computing system for carrying out the method, a method for generating a machine learned neural network for the method, a data structure, a machine, a mobile agent, a data processing system, and a computer program, machine-readable storage medium, or a data carrier signal.

### CROSS-REFERENCE TO RELATED APPLICATION

The present application claims the benefit and/or priority of Great Britain Patent Application No. 2215479.3 filed on Oct. 20, 2022, the content of which is incorporated by reference herein.

### TECHNICAL FIELD

This disclosure is related generally to learning models, and more specifically to learning neural networks for embedded applications.

### BACKGROUND

There is increasing interest in autonomous vehicles and robots and, as a result, increasing development of sophisticated embedded systems that can capture large volumes of data and then apply machine-learning strategies for performing prediction tasks that enable an autonomous vehicle or robot to make decisions while manoeuvring. State-of-the-art machine learning models have significantly grown in size in recent years, with increasing number of parameters to achieve better prediction performance. However, there is generally a trade-off between number of parameter size, inference time, and latency. Large models show great expressivity but are practically difficult to deploy for embedded applications where inference systems have relatively limited computational capabilities and relatively low memory. Additionally, prediction tasks for autonomous driving or robot control often require real-time or near real-time inference to ensure safety, but large models are usually slow in inference and have increased latency. Given the processing limitations of the hardware of an autonomous vehicle or robot, a deep learning model should produce the required predictions within a certain latency threshold, while still meeting the performance requirements.

### SUMMARY

It is an object of the present disclosure to provide an improved method of controlling a machine using a deep learning model for carrying out one or more prediction tasks on data from sensors of the machine, wherein the deep learning model is over-parameterized during training for better optimization and generalization and contracted down to a compact architecture for interference, therefore providing inference benefits associated with a smaller model while retaining the better performance of a large model. In general, the deep learning model includes at least one parameter tensor which was over-parameterized during training into a plurality of component tensors. During training, a subset of component tensors may be trained at each training epoch by updating the elements of the subset of component tensors while the elements of any other component tensors are frozen (not updated). Once the model is trained, the inference model is generated by combining or compressing the plurality of component tensors into the at least one parameter tensor. The combining or compression may be through element-wise addition, wherein each element of the at least one component tensor is added up to generate the at least one parameter tensor. This combines the benefits of improved optimization and generalization provided by a larger number of parameters during training with the faster inference performance associated with a smaller neural network, making the neural network ideal for embedded applications which have limited processing power.

The object of the present disclosure is addressed by the subject-matter of the independent claims, wherein further embodiments are incorporated into the dependent claims.

It shall be noted that all embodiments of the present disclosure concerning a method might be carried out with the order of the steps as described, nevertheless this has not to be the only and essential order of the steps of the method. The herein presented methods can be carried out with another order of the disclosed steps without departing from the respective method embodiment, unless explicitly mentioned to the contrary hereinafter.

To solve the above technical problems, the present disclosure provides a computer-implemented method for automatically controlling a machine, the method including:
receiving data generated using at least one sensor of a machine;
performing one or more prediction tasks on the data using a neural network, wherein the neural network includes at least one parameter tensor including at least one element, and the at least one parameter tensor was over-parameterized during training into a plurality of component tensors; and
controlling the machine based on results of the one or more prediction tasks.

The computer-implemented method of the present disclosure is advantageous over known methods as the neural network used to perform the one or more prediction tasks to control the machine has the performance benefits of an over-parameterized neural network which are generally more expressive and more generalizable, while maintaining a slim neural network for inference to reduce computing power and latency such that the neural network is suitable for real time inference for a machine.

A method of the present disclosure is a computer-implemented method as described above, wherein the plurality of component tensors include an identical number of elements as the at least one parameter tensor and was compressed by element-wise addition after training to generate the at least one parameter tensor.

The above-described aspect of the present disclosure has the advantage that by having component tensors with the same dimension as the parameter tensor that they are compressed into, over-parameterization is carried out at the element-level which makes the compression computationally cheap as compared to compression with additional multiplications or with extra epochs of training. Furthermore, the method may be applicable to a wide variety of neural networks (e.g., single-task and multi-task neural networks) and neural network layers, including linear (fully connected/dense) layers, convolutional layers, and multi-head self-attention layers.

A method of the present disclosure is a computer-implemented method as described above, wherein during training of the neural network, a subset of the plurality of component tensors is trained at each training epoch by updating elements of the subset of the plurality of component tensors while freezing elements of any other component tensors.

The above-described aspect of the present disclosure has the advantage that by only training a subset of component tensors at each training epoch, a wider variability in component tensors are trained and therefore leading to better performance after the component tensors have been compressed to generate the inference model. Furthermore, increased generalization is promoted as the component tensors are trained with reduced dependence on other component tensors.

A method of the present disclosure is a computer-implemented method as described above, wherein:
the subset of the plurality of component tensors includes one component tensor; and/or
the subset of the plurality of component tensors is selected randomly, wherein the selection is based on a probability of dropout associated with each of the plurality of component tensors.

The above-described aspect of the present disclosure has the advantage that cycling the training between the different component tensors ensures a wide variability of component tensors. A random of selection of the subset of plurality of components trained at each time also promotes generalization as the random selection prevents individual component tensors from depending on other component tensors.

A method of the present disclosure is a computer-implemented method as described above, wherein performing one or more prediction tasks on the data using a neural network includes:
carrying out a plurality of forward passes on the neural network to generate a plurality of predictions for each prediction task, wherein a subset of elements of the at least one parameter tensor is dropped out during each forward pass; and
determining a mean, variance and/or entropy for each of the prediction tasks based on the plurality of predictions generated for each prediction task.

The above-described aspect of the present disclosure has the advantage that an ensemble of predictions is generated for each prediction task, which may be used to compute mean, variance and entropy of the predictions. Using a predictive mean increases performance and achieves better neural network accuracy as the predictions from multiple forward passes reduces the variance of predictions and reduce generalization error. Furthermore, variance and entropy may be used to estimate the uncertainty of the prediction, which would potentially lead to more robust applications. For example, where prediction is high, and confidence is low, a higher number of sensor readings may be used to complement neural network to enhance prediction accuracy. For example, where uncertainty is low, a lower number of sensor readings may be used to reduce computational cost and reduce inference time.

A method of the present disclosure is a computer-implemented method as described above, wherein the one or more prediction tasks includes one or more of: semantic segmentation, depth estimation, object detection, instance segmentation, lane detection, surface normal estimation, travelable area estimation, traffic sign recognition, natural language processing, classification, regression, emotion detection, intent detection, named entity recognition, or sentence boundary detection.

The above-described aspect of the present disclosure has the advantage that each of the prediction tasks may be carried out by neural networks of various architectures and thus the method of the present disclosure may be applied to various prediction tasks regardless of the neural network architecture.

A method of the present disclosure is a computer-implemented method as described above, wherein:
the machine corresponds to a mobile agent; and
wherein controlling the machine based on results of the one or more prediction tasks includes steering the mobile agent, braking the mobile agent, parking the mobile agent, providing an alert to an operator of the mobile agent or a third party.

The above-described aspect of the present disclosure has the advantage that the neural network works well in a mobile agent that typically has limited processing power while still increasing the overall safety level on the roads due to better performance.

The above-described advantageous aspects of a computer-implemented method of the present disclosure also hold for all aspects of a below-described computing system of the present disclosure. All below-described advantageous aspects of a computing system of the present disclosure also hold for all aspects of an above-described computer-implemented method of the present disclosure.

The present disclosure also relates to a computing system for automatically controlling a machine, the computing system including one or more processors and memory storing one or more programs for execution by the one or more processors, the one or more programs including instructions for carrying out a computer-implemented method described above.

A computing system of the present disclosure is a computing system as described above, wherein the machine is a mobile agent, and the computing system is an embedded computing system of the mobile agent.

The above-described advantageous aspects of a computer-implemented method or computing system of the present disclosure also hold for all aspects of a below-described machine or mobile agent of the present disclosure. All below-described advantageous aspects of a machine or mobile agent of the present disclosure also hold for all aspects of an above-described computer-implemented method or computing system of the present disclosure.

The present disclosure also relates to a machine or mobile agent including at least one sensor and the computing system of the present disclosure.

The above-described advantageous aspects of a computer-implemented method, computing system, machine, or mobile agent of the present disclosure also hold for all aspects of a below-described computer-implemented method of the present disclosure. All below-described advantageous aspects of a computer-implemented method of the present disclosure also hold for all aspects of an above-described computer-implemented method, computing system, machine, or mobile agent of the present disclosure.

The present disclosure also relates to a computer-implemented method for generating a machine learned neural network that can perform one or more prediction tasks based on data of sensors of a machine for automatically controlling a machine, the computer-implemented method including:
training a learning neural network on a plurality of training datasets, the neural network including at least one over-parameterized parameter tensor, the at least one over-parameterized tensor including a plurality of component tensors;
generating a machine learned neural network for performing one or more prediction tasks on a dataset, the machine learned neural network including at least one parameter tensor that is a combination of the trained plurality of component tensors; and
embedding the machine learned neural network into a computing system for the machine such that the computing system can perform the one or more prediction tasks on the sensor data of the machine and control the machine based on results of the one or more prediction tasks.

The computer-implemented method of the present disclosure is advantageous over known methods as the machine learned neural network has the performance benefits of an over-parameterized neural network which are generally more expressive and more generalizable, while maintaining a slim neural network for inference to reduce computing power and latency when embedded in a computing system of a machine.

A method of the present disclosure is a computer-implemented method as described above, wherein the trained plurality of component tensors include an identical number of elements as the at least one parameter tensor and was compressed by element-wise addition to generate the at least one parameter tensor.

The above-described aspect of the present disclosure has the advantage that compression of the at least one trained plurality of component tensors to generate the at least one parameter tensor is computationally cheap as compared to compression on a matrix level or convolution level.

A method of the present disclosure is a computer-implemented method as described above, wherein training the learning neural network includes training a subset of the plurality of component tensors at each training epoch by updating elements of the subset of the plurality of components while freezing elements of any other component tensors.

The above-described aspect of the present disclosure has the advantage that by only training a subset of component tensors at each training epoch, a wider variability in component tensors are trained and therefore leading to better performing trained neural network. Furthermore, increased generalization is promoted as the component tensors are trained with reduced dependence on other component tensors.

A method of the present disclosure is a computer-implemented method as described above, wherein:
the subset of the plurality of component tensors including one component tensor; and/or
the subset of the plurality of component tensors is selected randomly, wherein the selection is based on a probability of dropout associated with each of the plurality of component tensors.

The above-described aspect of the present disclosure has the advantage that cycling the training between the different component tensors ensures a wide variability of component tensors. A random selection of the subset of plurality of components trained at each time also promotes generalization as the random selection prevents individual component tensors from depending on other component tensors.

A method of the present disclosure is a computer-implemented method as described above, wherein the one or more prediction tasks includes one or more of: semantic segmentation, depth estimation, object detection, instance segmentation, lane detection, surface normal estimation, travelable area estimation, traffic sign recognition, natural language processing, classification, regression, emotion detection, intent detection, named entity recognition, or sentence boundary detection.

The above-described aspect of the present disclosure has the advantage that each of the prediction tasks may be carried out by neural networks of various architectures and thus the method of the present disclosure may be applied to various prediction tasks regardless of the neural network architecture.

A method of the present disclosure is a computer-implemented method as described above, wherein the machine corresponds to a mobile agent and controlling the machine based on results of the one or more prediction tasks includes steering the mobile agent, braking the mobile agent, parking the mobile agent, providing an alert to an operator of the mobile agent or a third party.

The above-described aspect of the present disclosure has the advantage that the machine learned neural network works well in a mobile agent that typically has limited processing power while still increasing the overall safety level on the roads due to better performance.

The above-described advantageous aspects of a computer-implemented method, computing system, machine, or mobile agent of the present disclosure also hold for all aspects of a below-described data structure of the present disclosure. All below-described advantageous aspects of a data structure of the present disclosure also hold for all aspects of an above-described computer-implemented method, computing system, machine, or mobile agent of the present disclosure.

The present disclosure also relates to a data structure generated by a computer-implemented method of the present disclosure.

The above-described advantageous aspects of a computer-implemented method, computing system, machine, mobile agent, or data structure of the present disclosure also hold for all aspects of a below-described data processing system of the present disclosure. All below-described advantageous aspects of a data processing system of the present disclosure also hold for all aspects of an above-described computer-implemented method, computing system, machine, mobile agent, or data structure of the present disclosure.

A data processing system includes means for performing the steps of a computer-implemented method according to the present disclosure.

The above-described advantageous aspects of a computer-implemented method, computing system, machine, mobile agent, data structure, or data processing system of the present disclosure also hold for all aspects of a below-described computer program, a machine-readable storage medium, or a data carrier signal of the present disclosure. All below-described advantageous aspects of a computer program, a machine-readable storage medium, or a data carrier signal of the present disclosure also hold for all aspects of an above-described computer-implemented method, computing system, machine, mobile agent, data structure, or data processing system of the present disclosure.

The present disclosure also relates to a computer program, a machine-readable storage medium, or a data carrier signal that includes instructions, that upon execution on a data processing device and/or control unit, cause the data processing device and/or control unit to perform the steps of a computer-implemented method according to the present disclosure. The machine-readable medium may include any medium and/or mechanism for storing or transmitting information in a form readable by a machine (e.g., a computing device). The machine-readable medium may be any medium, such as for example, read-only memory (ROM); random access memory (RAM); a universal serial bus (USB) stick; a compact disc (CD); a digital video disc (DVD); a data storage device; a hard disk; electrical, acoustical, optical, or other forms of propagated signals (e.g., digital signals, data carrier signal, carrier waves), or any other medium on which a program element as described above can be transmitted and/or stored.

As used in this summary, in the description below, in the claims below, and in the accompanying drawings, the term “sensor” includes any sensor that detects or responds to some type of input from a perceived environment or scene.

As used in this summary, in the description below, in the claims below, and in the accompanying drawings, the term “mobile agent” refers to any mobile agent capable of movement, including cars, trucks, buses, agricultural machines, forklift, robots, whether or not such mobile agent is capable of carrying or transporting goods, animals, or humans, whether or not such mobile agent is capable of moving on land, sea, or air, and whether or not such mobile agent is driven by a human or is autonomous.

### BRIEF DESCRIPTION OF THE DRAWINGS

These and other features, aspects, and advantages will become better understood with regard to the following description, appended claims, and accompanying drawings where:

FIG. 1 is a schematic illustration of a neural network that may be used for automatically controlling a machine, in accordance with embodiments of the present disclosure;

FIG. 2 is a schematic illustration of an example of the over-parameterization of a parameter tensor, in accordance with embodiments of the present disclosure;

FIG. 3 is a block diagram of a method for building a neural network configured for performing one or more prediction tasks, in accordance with embodiments of the present disclosure;

FIG. 4 illustrates an embedded system that may implement a neural network trained according to the principles of the present disclosure, in accordance with embodiments of the present disclosure;

FIG. 5 is a schematic illustration of a method for automatically controlling a machine, in accordance with embodiments of the present disclosure;

FIG. 6 is a schematic illustration of a method of processing data by a neural network in multiple forward passes, in accordance with embodiments of the present disclosure;

FIG. 7 illustrates an example of a computing system, in accordance with embodiments of the present disclosure;

FIGS. 8 and 9 show the results on experiments conducted on the CIFAR-100 dataset, in accordance with embodiments of the present disclosure; and

FIGS. 10 to 12 show the results of experiments conducted on the NYU Depth Dataset v2 dataset, in accordance with embodiments of the present disclosure.

In the drawings, like parts are denoted by like reference numerals.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the summary above, in this description, in the claims below, and in the accompanying drawings, reference is made to particular features (including method steps) of the present disclosure. It is to be understood that the disclosure in this specification includes all possible combinations of such particular features. For example, where a particular feature is disclosed in the context of a particular aspect or embodiment of the present disclosure, or a particular claim, that feature can also be used, to the extent possible, in combination with and/or in the context of other particular aspects and embodiments of the present disclosure, and in the present disclosures generally.

In the present document, the word “exemplary” is used herein to mean “serving as an example, instance, or illustration.” Any embodiment or implementation of the present subject matter described herein as “exemplary” is not necessarily be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the scope of the disclosure.

The present disclosure is directed to computer-implemented methods, computing systems, data structures, data processing systems, mobile agents, computer programs, machine-readable storage media, and data carrier signals for controlling a machine by carrying out one or more prediction tasks on data from sensors of the machine using a neural network which has improve performance while maintaining a limited inference model parameter set, which directly correlates with inference computational budget, memory, latency and inference time. The neural network may be either single-task and multi-task neural network. The neural network may be applied to real-time prediction tasks for automated or semi-automated driving of mobile agents, such as vehicles and/or robots. A neural network according to the principles described herein, can be used for datasets from any type of sensor. A neural network, according to the principles described herein, can be used for autonomous or semi-autonomous mobile agents of any type, including cars and trucks, passenger aircraft, unmanned aerial vehicles (UAV), trains, boats, ships, etc.

According to various embodiments, the neural network may include at least one parameter tensor representing at least one layer of the neural network. The at least one parameter tensor may be for a single-task prediction or a multi-task prediction. The at least one parameter tensor may be replaced with a plurality of component tensors during training. The plurality of component tensors may be trained at each training epoch. A subset of the plurality of component tensors may be trained at each training epoch to encourage variability and reduce dependence on other component tensors. For inference, the component tensors are combined, compressed, or contracted back into a compact parameter tensor in the inference neural network. The combination may be through element-wise addition which is computationally cheap as compared to compression with additional multiplications or with extra epochs of training. The at least one parameter tensor may represent any type of neural network layer, including linear (fully connected/dense) layers, convolutional layers, and multi-head self-attention layers.

According to various embodiments, for inference using the neural network, the inference may be carried out a single forward. Inference may be carried out as multiple forward passes, wherein a subset of elements of the parameter tensor may drop out for each forward pass to generate an ensemble of predictions. Such ensemble of predictions may be used to compute mean, variance and/or entropy of the predictions, to achieve better model performance with the predictive mean and to estimate uncertainty of the prediction with the variance and entropy.

The following description sets forth exemplary methods, parameters, and the like. It should be recognized, however, that such description is not intended as a limitation on the scope of the present disclosure but is instead provided as a description of exemplary embodiments.

The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. The terms “comprises,” “comprising”, “includes” or any other variations thereof, are intended to cover a non-exclusive inclusion, such that a setup, device or method that includes a list of components or steps does not include only those components or steps but may include other components or steps not expressly listed or inherent to such setup or device or method. In other words, one or more features in a system or apparatus proceeded by “comprises . . . a” does not, without more constraints, preclude the existence of other features or additional features in the system or method. It must also be noted that as used herein and in the appended claims, the singular forms “a,” “an,” and “the” include plural references unless the context clearly dictates otherwise.

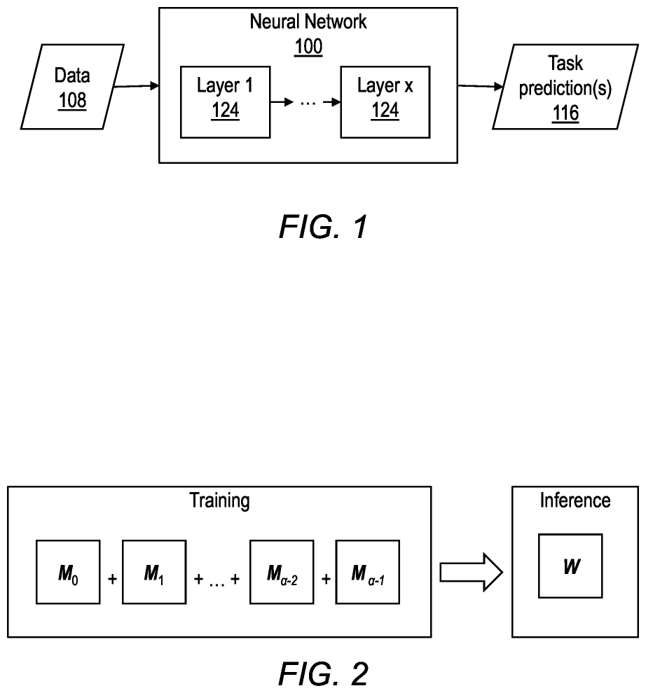

FIG. 1 is a schematic illustration of a neural network 100 that may be used for automatically controlling a machine, in accordance with embodiments of the present disclosure. In some embodiments, neural network 100 may receive data 108 as input and may output one or more task predictions 116. In some embodiments, data 108 may be generated using at least one sensor of a machine. Data 108 may be any data from any sensor, including images, frames of a video, auditory data, etc.

According to some embodiments, neural network 100 may include at least one layer 124. The at least one layer 124 may be any type of neural network layer, including linear (fully connected/dense) layers, convolutional layers, and multi-head self-attention layers. In some embodiments, each layer 124 of neural network 100 may be expressed as at least one parameter tensor W including at least one element. For example, a linear (fully connected/dense) layer may be expressed as parameter tensor W ∈ [symbol] ^{m×n} given input size m and output size n. For example, a convolutional layer may be expressed as parameter tensor W ∈ [symbol] ^{c}^{ᵢ}^{×c}^{ᵢ₋₁}^{×k×k}, where cᵢ₋₁ and cᵢ are the corresponding input and output channel dimensions (where the input and output dimensions are of size h×w×cᵢ₋₁ and h×w×cᵢ) and k is the filter size. For example, a multi-head self-attention layer given input size m, output size n, and number of heads h may be expressed as three parameter tensors Wₖ ∈ [symbol] ^{m×n×h}, W_{q} ∈ [symbol] ^{m×n×h}, and Wᵥ ∈ [symbol] ^{m×n×h}. It is emphasised that the examples of parameter tensors listed herein do not indicate biases. In some embodiments, the at least one parameter tensor W was over-parameterized into a plurality of component tensors M for training and compressed back to a compact set for inference, as discussed further below.

FIG. 2 is a schematic illustration of an example of the over-parameterization of a parameter tensor, in accordance with embodiments of the present disclosure. The parameter tensor for a given layer 124 of neural network 100 is over-parameterized for training into component tensors M during training and compressed after training to provide parameter tensor W for the given layer 124. Parameter tensor W is used for neural network 100 for inference and can be deployed, for example, in an embedded system.

Practically, any number of layers of neural network 100 may be over-parameterized during training using the principles described above to improve the performance of neural network 100 during implementation and inference. In some variations, just a single layer out of a plurality of layers in the neural network 100 is over-parameterized. In other variations, all layers of neural network 100 are over-parameterized. It will be understood that any share of the layers of neural network 100 may be over-parameterized during training.

According to some embodiments, the parameter tensor W may be over-parameterized into a component tensors M₀, M₁, . . . M_{α-2}, M_{α-1} based on an over-parameterization factor a wherein a is a positive integer, or a α ∈ [symbol] ⁺. The plurality of component tensors may be expressed as a set {Mⱼ}. For example, where parameter tensor W includes |θ| elements, the over-parameterized parameter tensor W would include α|θ| elements, or α times the original number of elements. In one aspect, a is above one to avoid a trivial case where no over-parameterization is performed.

According to some embodiments, each component tensor M may include an identical number of elements as the corresponding parameter tensor W. In other words, each component tensor M may include the same dimensions as the corresponding parameter tensor W. For example, where parameter tensor W is expressed as W ∈ [symbol] ^{c}^{ᵢ}^{×c}^{ᵢ₋₁}^{×k×k}the plurality of component tensors Mⱼ may be expressed as Mⱼ ∈ [symbol] ^{c}^{ᵢ}^{×c}^{ᵢ₋₁}^{×k×k} for j ∈ {0, . . . , α−1}.

During training, the plurality of component tensors M are updated using a loss function. In some embodiments, where neural network 100 is a single-task neural network with a single prediction task, the loss may be a neural network loss [symbol] . In some embodiments, where neural network 100 is a multi-task neural network with multiple prediction tasks, the loss may be a task-specific loss [symbol] . In some embodiments, the plurality of component tensors M is trained in each epoch. In some embodiments, a subset of the plurality of component tensors M is trained in each epoch. The training of the plurality of component tensors M is discussed further below.

According to some embodiments, the plurality of component tensors Mⱼ may be compressed after training to generate parameter tensor W for inference. In some embodiments, the compression may be through element-wise addition. In some embodiments, parameter tensor W for inference may be expressed as W=Σⱼ₌₀^{α-1}Mⱼ.

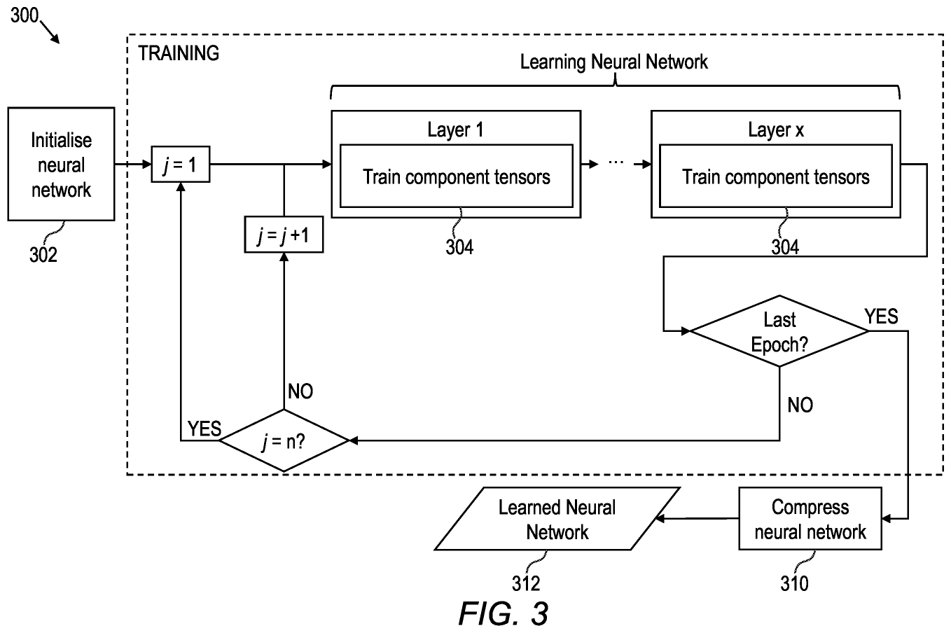

FIG. 3 is a block diagram of a method 300 for building a neural network configured for performing one or more prediction tasks, in accordance with embodiments of the present disclosure. Method 300 can be used, for example, for building neural network 100 of FIG. 1. Method 300 is a simplified representation of the training process for training a neural network, focusing on the aspects of training associated with the over-parameterization of the parameter tensor(s). Other aspects of training a neural network would be well understood to a person having ordinary skill in the art and, therefore, are omitted for brevity.

In general, a neural network for which method 300 may be used to train includes at least one parameter tensor representing each layer of the neural network. The at least one parameter tensor of each layer is over-parameterized into a component tensors M₀, M₁, . . . M_{α-2}, M_{α-1} for training.

At step 302, the neural network is initialized. Training begins at step 304, with updating the component tensors M of the first layer of the neural network based on training data (also termed as “vanilla” training method). In particular, the elements of component tensors M are updated. The training data may be any data that may be generated by at least one sensor.

According to some embodiments, only a subset of component tensors Mis trained at each epoch, and only the elements of the subset of component tensors M are updated at each epoch. In some embodiments, when updating the elements of the subset of component tensors M, the elements of any other component tensors M are frozen (i.e., not updated or changed). According to some embodiments, the subset of component tensors may include one component tensor, such that only one component tensor is updated at each epoch (also termed as “cycling” training method). In some embodiments, the subset of component tensors may include any number of component tensors that are randomly selected. In some embodiments, the subset of component tensors may be randomly selected based on a probability of dropout (p_{drop}) associated with each of the plurality of component tensors (also termed as “dropout” training method). In some embodiments, the probability of dropout may be the same for all the component tensors. In some embodiments, the probability of dropout may be different for each component tensor. For example, p_{drop} may be any number in the range 0.1<p_{drop}<0.9.

The subset of component tensors M may be updated using a loss function. Where the neural network is a single-task neural network, updating of component tensor M may be done using a neural network loss [symbol] . In some embodiments, where the neural network is a multi-task neural network with multiple prediction tasks, the loss may be a task-specific loss [symbol] . Step 304 is repeated for each layer of the neural network for a training epoch. Note that training processes associated with other structure of the neural network are not shown for simplicity.

According to some embodiments, each epoch may include the updating of a different set of component tensors M from the prior epoch. A first epoch may include updating the elements of a first subset of component tensors, and a second epoch may include updating the elements of a second subset of component tensors. Step 304 is repeated for the layers of the neural network for the requisite number of epochs.

After the last epoch, method 300 may proceed with step 310 wherein the component tensors for each layer are compressed, as described above, resulting in an inference parameter tensor W, which is built into a learned neural network 312 that may be implemented in an embedded system.

Method 300 may be performed using suitable training datasets. The training dataset should include a wide range of distributed examples of labelled input data. For example, where the sensor is an imaging sensor and the data is images, the training data may be suitable training images. The training images may be selected and pre-processed to be the same height and width. The training images may be annotated by human labellers to include labels for the task(s) that the neural network is to perform. For example, for an object detection task, training image labelling includes an image file name, bounding box coordinates, and the object name. As is understood by a person of skill in the art, different tasks may have different labels corresponding to the task.

According to some embodiments, where the neural network is a multi-task neural network, the training dataset may be jointly-labelled, disjointly-labelled, or some combination of both. This means that a single training dataset (e.g., a single training image) can have labels for a single task or multiple tasks to be trained simultaneously together. For either jointly-labelled or disjointly-labelled datasets, each training batch can include a mixed dataset from different tasks. The dataset can be mixed for the different tasks using any suitable distribution, such as a uniform distribution.

To illustrate the above points, for a jointly-labelled training dataset used to train a 4-task neural network with a batch size of 256 training images, all 256 training images have labels for all 3 tasks, and the neural network is trained simultaneously for all 4 tasks. In contrast, for disj ointly-labelled training dataset used to train a 4-task neural network with a batch size of 256 training images, there may be 64 training images labelled for each task (for a uniform distribution). During training, the 256 training images are loaded in together as one batch and the neural network is trained simultaneously for all 4 tasks. In this training batch, each task-specific portion is updated by losses received from only its associated 64 images, whereas the shared portion is updated by losses received from the 256 images all together.

An example of an algorithm to train a subset of component tensors including a single component tensor at each epoch for a single task neural network including convolutional layers is as follows:

```
let α ϵ [symbol]    ⁺ be the over-parameterization factor
for each convolution layer ϵ neural network do
  overparameterize W = Σⱼ₌₀^{α-1} Mⱼ
end for
for each epoch e do
  define training index j′ ← e (mod α)
  for each convolution layer ϵ model do
    for Mⱼ ϵ {Mₗ} do
      if j = j′ then
        allow gradient backpropagation of Mⱼ
      else
        freeze gradient backpropagation of Mⱼ
      end if
    end for
  end for
  perform neural network training using neural network loss [symbol]
end for
```

An example of an algorithm to train a subset of component tensors including a single component tensor at each epoch for a multi-task neural network having convolutional layers is as follows:

```
let |T| ϵ [symbol]    ⁺ be the number of tasks for multi-task learning
let α ϵ [symbol]    ⁺ where α ≥ |T| be the over-parameterization factor
for each convolution layer ϵ neural network do
  overparameterize W = Σⱼ₌₀^{α-1} Mⱼ
end for
for each epoch e do
  for each convolution layer ϵ neural network do
    for Mⱼ ϵ {Mₗ} do
      if j ≡ e(mod |T|) then
        allow gradient backpropagation of Mⱼ
      else
        freeze gradient backpropagation of Mⱼ
      end if
    end for
  end for
  perform model training using task-specific loss [symbol]    _{(mod |T|)}
end for
```

An example of an algorithm to train a subset of component tensors including a random selection of component tensors based on a probability of dropout associated with each of the plurality of component tensors is as follows:

```
let α ∈ [symbol]    ⁺ be the over-parameterization factor
let p_{drop} be the drop probability
for each convolution layer ∈ neural network do
  overparameterize W = Σⱼ₌₀^{α-1} Mⱼ
end for
for each epoch e do
  for each convolution layer ∈ neural network do
    selected ← [ ]
    while selected = [ ] do
      for Mⱼ ∈ {Mₗ} do
        generate random number r ∈ [0,1]
        if r > p_{drop} then
          append j in selected
        end if
      end for
    end while
    $W ← \frac{α}{\vert selected \vert} {\sum }_{j ∈ selected} {M}_{j}$
  end for
  perform neural network training using neural network loss [symbol]
end for
```

It is emphasized that the algorithms described above are only examples of how the subsets of component factors may be trained and other algorithms may be implemented.

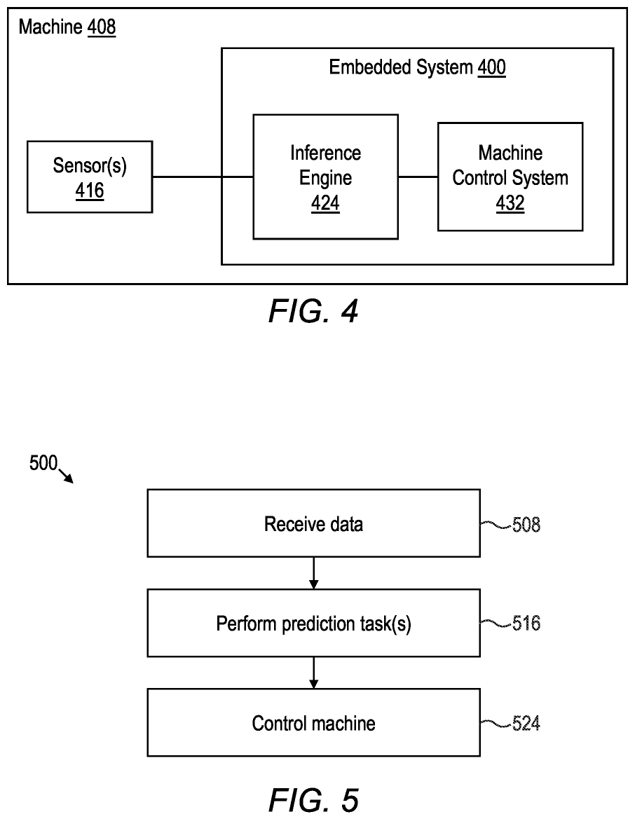

FIG. 4 illustrates an embedded system 400 that may implement a neural network trained according to the principles discussed above, such as learned neural network 312 of FIG. 3, in accordance with embodiments of the present disclosure. Embedded system 400 may be installed in a machine 408 for performing one or more prediction tasks on data generated using one or more sensors 416. The one or more sensors 416 may include one or more sensors mounted on the machine. For example, where the machine is a mobile agent (e.g., a vehicle or robot), the one or more sensors 416 may include one or more forward-facing sensors, one or more rearward-facing sensors, and/or one or more cabin-facing sensors. In some embodiments, the sensors may be any sensor suitable for perceiving an environment of the machine, including visible light cameras, lidar cameras, radar sensors, ultrasound sensors, audio sensors, or any other sensor technology.

Embedded system 400 includes an inference engine 424 that implements the neural network for performing one or more prediction tasks on the data received from the one or more sensors 416. The neural network may be configured for any suitable number and combination of prediction tasks. Examples of inference tasks include semantic segmentation, depth estimation, object detection, instance segmentation, lane detection, surface normal estimation, travelable area estimation, traffic sign recognition, natural language processing, classification, regression, emotion detection, intent detection, named entity recognition, or sentence boundary detection.

The inference engine 424 outputs predictions associated with each prediction task. These predictions may be provided to a machine control system 432, which may use the predictions machine control. For example, where the machine is a mobile agent (e.g., a vehicle or robot), the predictions may be used for autonomous or semi-autonomous mobile agent control. Machine control system 432 may a part of embedded system 400 or may be a separate system that is communicatively connected to control system 432. Machine control system 432 may include or be communicatively connected to one or more machine systems of the machine. Examples of the one or more machine systems of a mobile agent include a steering system, a braking system, an acceleration system, and an operator interface system (which may include, for example, an on-vehicle display for communicating to the operator). In some embodiments, the machine control system 432 controls the machine. For example, where the machine is a mobile agent, the machine control system may control at least one of steering the mobile agent, braking the mobile agent, parking the mobile agent, or providing an alert to an operator of the mobile agent or a third party based on the predictions from the inference engine 424. In one example, the machine control system 432 may control braking of the mobile agent according to a distance to an obstruction on the road based on, for example, a semantic segmentation, object detection, and depth estimation output from the inference engine 424. In another example, the machine control system 432 may control the mobile agent by responding to the operator of the mobile agent based on, for example, an emotion detection, intent detection, named entity recognition and sentence boundary detection output from the inference engine 424.

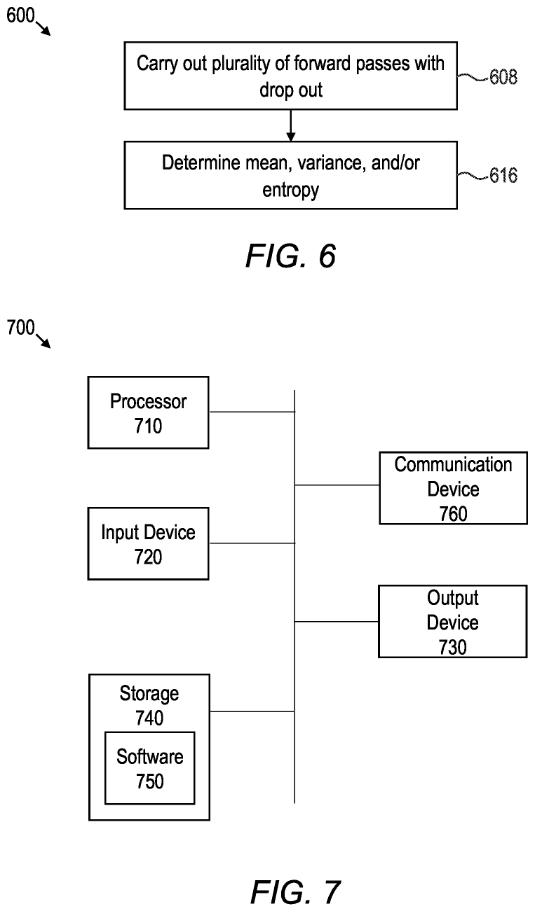

FIG. 5 is a schematic illustration of a method 500 for automatically controlling a machine, in accordance with embodiments of the present disclosure. Method 500 of automatically controlling a machine may be implemented by any architecture and/or computing system. For example, various architectures employing, for example, multiple integrated circuit (IC) chips and/or packages, and/or various computing devices and/or consumer electronic (CE) devices such as multi-function devices, tablets, smart phones, etc., may implement the techniques and/or arrangements described herein. In some embodiments, method 500 may be performed by an embedded computing system deployed in a machine to support machine operation and/or control. In some embodiments, method 500 may be performed by an embedded computing system deployed in a mobile agent in support of autonomous mobile agent operation (e.g., autonomous vehicle or autonomous robot). At step 508, data is received from at least one sensor of a machine. The sensor may be any type of sensor, including temperature, proximity, infrared, pressure, light, sound, or color sensor. The data received may be any type of data, including images, frames of a video, auditory data, etc. At step 516, the data is processed by a neural network, such as neural network 100 of FIG. 1 or trained neural network 312 of FIG. 3, which performs one or more prediction tasks. In some embodiments, the data may be processed by the neural network in a single forward pass. In some embodiments, the data may be processed by the neural network in multiple forward passes, as described below in relation to FIG. 6. At step 524, the machine is controlled based on the results of the one or more prediction tasks carried out in step 516. Where the machine is a mobile agent, examples of controlling the mobile agent include steering the mobile agent, braking the mobile agent, parking the mobile agent, and/or providing an alert to an operator of the mobile agent or a third party.

FIG. 6 is a schematic illustration of a method 600 of processing data by a neural network in multiple forward passes, in accordance with embodiments of the present disclosure. Method 600 of processing data by a neural network in multiple passes may be implemented by any architecture and/or computing system. For example, various architectures employing, for example, multiple integrated circuit (IC) chips and/or packages, and/or various computing devices and/or consumer electronic (CE) devices such as multi-function devices, tablets, smart phones, etc., may implement the techniques and/or arrangements described herein. In some embodiments, method 600 may be performed by an embedded computing system deployed in a machine to support machine operation and/or control. In some embodiments, method 600 may be performed by an embedded computing system deployed in a mobile agent in support of autonomous mobile agent operation (e.g., autonomous vehicle or autonomous robot). In some embodiments, method 600 may be carried out at step 516 of method 500.

At step 608, a plurality of forward passes may be carried out on the neural network to generate a plurality of predictions (or ensemble of predictions) for each prediction task. In some embodiments, a subset of elements of the at least one parameter tensor is dropped out during each forward pass such that, for each forward pass, the neural network may stochastically switch off a different set of neurons and outputs a prediction for the prediction task. Multiple forward passes with different dropout configurations may yield a predictive distribution as an ensemble. In some embodiments, the dropout rate may be between 0-0.5 and may be determined based on neural network type, layer size, and/or dataset. In some embodiments, 30 to 100 forward passes may be carried out.

At step 616, the plurality of predictions may be used to compute mean, variance and/or entropy of the prediction to achieve better neural network performance with the predictive mean and to estimate an uncertainty of the prediction based on variance and entropy. For example, mean may be calculated using the equation μ= 1/NΣₙxₙ, where xₙ represents the predictions given the number of predictions n. For example, variance may be calculated using the equation σ²= 1/NΣₙ(xₙ−μ)², where μ represents the mean, σ² represents the variance, and xn represents the predictions given the number of predictions n. For example, entropy for a classification task may be calculated using the equation H≅−Σ_{c}^{c}(μ_{c})log(μ_{c}), where μ_{c}= 1/NΣₙp_{c}ⁿ is the class-wise mean softmax score, H represents entropy, p_{c} represents the probability generated for a class c. In some embodiments, the predictive mean may be used to determine the appropriate control for the machine in subsequent steps. In some embodiments, the variance and entropy may be used for uncertainty estimation to assist in the determination of the appropriate control of the machine in subsequent steps. For example, in safety-critical applications such as an automatic braking system, additional sensor readings may be used to enhance prediction accuracy if the estimated uncertainty is high (i.e., low confidence). For example, if the estimated uncertainty is low, one or more sensors may be omitted in subsequent prediction tasks to reduce computational cost and reduce inference time.

FIG. 7 illustrates an example of a computing system 700, in accordance with embodiments of the present disclosure. Computing system 700 can be used, for example, for training a neural network, for example, according to method 300 of FIG. 3. Computing system 700 can be used for one or more of components of embedded system 400 of FIG. 4. System 700 can be a computer connected to a network. System 700 can be a client or a server. As shown in FIG. 7, system 700 can be any suitable type of processor-based system, such as a personal computer, workstation, server, handheld computing device (portable electronic device) such as a phone or tablet, or an embedded system or other dedicated device. The system 700 can include, for example, one or more of input device 720, output device 730, one or more processors 710, storage 740, and communication device 760. Input device 720 and output device 730 can generally correspond to those described above and can either be connectable or integrated with the computing system 700.

Input device 720 can be any suitable device that provides input, such as a touch screen, keyboard or keypad, mouse, gesture recognition component of a virtual/augmented reality system, or voice-recognition device. Output device 730 can be or include any suitable device that provides output, such as a display, touch screen, haptics device, virtual/augmented reality display, or speaker.

Storage 740 can be any suitable device that provides storage, such as an electrical, magnetic, or optical memory including a RAM, cache, hard drive, removable storage disk, or other non-transitory computer readable medium. Communication device 760 can include any suitable device capable of transmitting and receiving signals over a network, such as a network interface chip or device. The components of the computing system 700 can be connected in any suitable manner, such as via a physical bus or wirelessly.

Processor(s) 710 can be any suitable processor or combination of processors, including any of, or any combination of, a central processing unit (CPU), graphics processing unit (GPU), field programmable gate array (FPGA), and application-specific integrated circuit (ASIC). Software 750, which can be stored in storage 740 and executed by one or more processors 710, can include, for example, the programming that embodies the functionality or portions of the functionality of the present disclosure (e.g., as embodied in the devices as described above). For example, software 750 can include one or more programs for execution by one or more processor(s) 710 for performing one or more of the steps of method 300, method 500, and/or method 600.

Software 750 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 740, that can contain or store programming for use by or in connection with an instruction execution system, apparatus, or device.

Software 750 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to, an electronic, magnetic, optical, electromagnetic, or infrared wired or wireless propagation medium.

System 700 may be connected to a network, which can be any suitable type of interconnected communication system. The network can implement any suitable communications protocol and can be secured by any suitable security protocol. The network may include network links of any suitable arrangement that can implement the transmission and reception of network signals, such as wireless network connections, T1 or T3 lines, cable networks, DSL, or telephone lines.

System 700 can implement any operating system suitable for operating on the network. Software 750 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

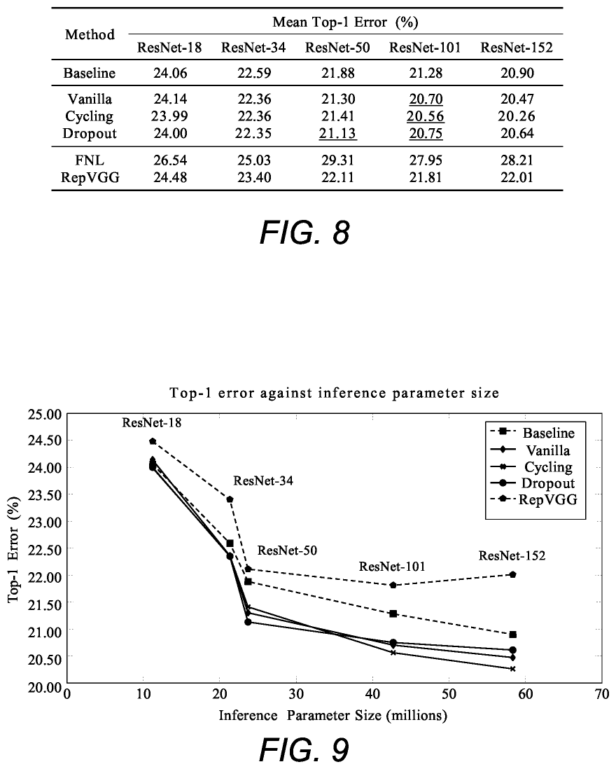

FIGS. 8 and 9 show the results on experiments conducted on the CIFAR-100 dataset, in accordance with embodiments of the present disclosure. In particular, the experiments conducted on the CIFAR-100 dataset include the evaluation of the methods of the present disclosure carried out on a single task neural network for image classification. The CIFAR-100 dataset may be found at https://www.cs.toronto.edu/˜kriz/cifar.html and is described in “Learning Multiple Layers of Features from Tiny Images” by Alex Krizhevsky, 2009. The CIFAR-100 dataset includes 100 classes containing 600 images of dimensions 32×32 each. The metric used to assess performance is the top-1 error, which is defined as the rate which the predicted class is different from the ground truth. The top-1 error also corresponds to 100%—accuracy. The model used in the image classification task of this experiment is ResNet, trained using a cross-entropy loss. Information on the architecture and training of ResNet may be found in “Deep Residual Learning for Image Recognition” by He et. al. In particular, the method is tested using different depths of ResNet, which are 18, 34, 50, 101 and 152-layers ResNet. Experiments are conducted on the CIFAR-100 dataset using the following methods:
a) a baseline method that uses ResNet to perform image classification without over-parameterization;
b) the vanilla training method disclosed herein wherein the parameter tensor is overparameterized with an over-parameterization factor α ∈ {2, . . . ,9} , and the plurality of component tensors are updated at each training epoch;
c) the cycling training method disclosed herein wherein the parameter tensor is overparameterized with an over-parameterization factor α ∈ {2, . . . ,9} , and a single component tensor is updated at each training epoch;
d) the dropout training method disclosed herein wherein the parameter tensor is overparameterized with an over-parameterization factor α ∈ {2, . . . ,9} , and a subset of component tensors is updated at each training epoch, the subset of component tensors determined based on p_{drop} of 0.3;
e) an over-parameterization method named FNL disclosed in “Initialization and Regularization of Factorized Neural Layers” by Khodak et. al. with Frobenius decay (λ=10⁻⁴); and
f) an over-parameterization method named RepVGG disclosed in “RepVGG: Making VGG-style ConvNets Great Again” by Ding et. al.

For the experiments, the following hyperparameters were used:
a) Stochastic gradient descent optimiser with momentum 0.9 and weight decay 5×10⁻⁴
b) Multi-step learning rate scheduler with initial learning rate 0.1
c) Total number of epochs is 200 epochs

It can be observed that for each method, the lowest mean top-1 errors are consistently achieved by one of the training methods of the present disclosure, while keeping the inference parameter size lower than the baseline experiments. For example, it can be observed that using dropout training method for ResNet-50 has better performance than the ResNet-101 baseline. It can also be observed that FNL and RepVGG did not perform well, even when compared to the baseline experiments.

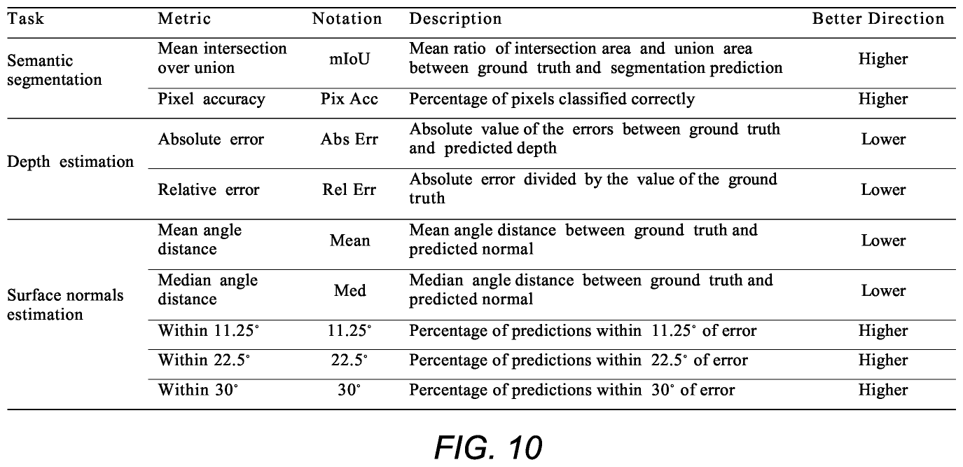

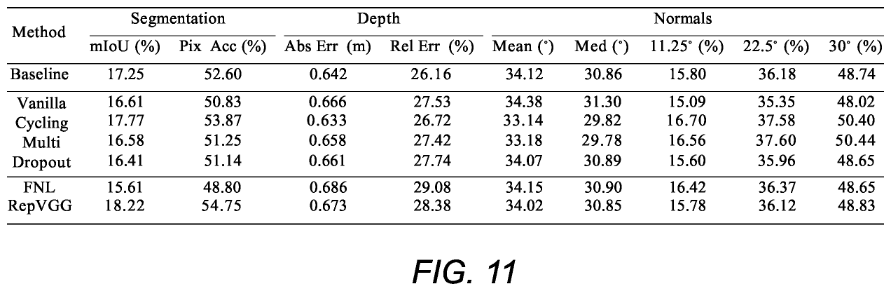

FIGS. 10 to 12 show the results of experiments conducted on the NYU Depth Dataset v2, in accordance with embodiments of the present disclosure. In particular, the experiments conducted on the NYU Depth Dataset v2 (NYUv2) include the evaluation of the methods of the present disclosure carried out on a multi-task neural network for image classification. NYUv2 dataset is available at https://cs.nyu.edu/˜silberman/datasets/nyu_depth_v2.html and is described in “Indoor Segmentation and Support Inference from RGBD Images” by Silberman et. al. in ECCV 2012. The NYUv2 dataset includes video sequences from indoor scenes taken using Microsoft Kinect. In particular, the three tasks to be performed, aggregated with a uniform weighting, are as follows:
a) Semantic segmentation. Each pixel is classified into one of the 13 defined classes. The loss function used for this task is depth-wise cross-entropy. The performance for this task is measured using mean intersection over union (mloU) and pixel accuracy, both of which, the higher the better.
b) Depth estimation. The depth at each pixel is estimated. The loss function used for this task is the L₁ norm between the prediction and the actual depth. The performance for this task is measured using absolute error and relative error, both of which, the lower the better.
c) Surface normals estimation. The angle of surface normal at each pixel is estimated.

The loss function used for this task is cosine similarity. The performance for this task is measured using angle distance measures (mean and median) as well as within angle t° measures (11.25°, 22.5° and 30°). Note that the lower the angle distance measures and the higher the within angle t° measures, the better.

A summary of the metrics with their notations and descriptions is presented in FIG. 10. The model used is SegNet adapted for multi-task learning as disclosed in “Knowledge Distillation for Multi-task Learning” by Li and Bilen. Experiments are conducted on the NYUv2 dataset using various methods:
a) a baseline method that uses SegNet for multi-task learning without over-parameterization;
b) the vanilla training method disclosed herein wherein the parameter tensor is overparameterized with an over-parameterization factor α ∈ {2, . . . ,9} , and the plurality of component tensors are updated at each training epoch;
c) the cycling training method disclosed herein wherein the parameter tensor is overparameterized with an over-parameterization factor α ∈ {2, . . . ,9} , a single component tensor is updated at each training epoch using an overall loss for all epochs;
d) the multi-task cycling method disclosed herein wherein the parameter tensor is overparameterized with an over-parameterization factor α ∈ {2, . . . ,9} , a single component tensor is updated at each training epoch using an alternating use of task-specific losses at each epoch;
e) the dropout training method disclosed herein wherein the parameter tensor is overparameterized with an over-parameterization factor α ∈ {2, . . . ,9} , and a subset of component tensors is updated at each training epoch, the subset of component tensors determined based on p_{drop} of 0.3;
f) an over-parameterization method named FNL disclosed in “Initialization and Regularization of Factorized Neural Layers” by Khodak et. al. with Frobenius decay (λ=10⁻⁴); and
g) an over-parameterization method named RepVGG disclosed in “RepVGG: Making VGG-style ConvNets Great Again” by Ding et. al.

For the experiments, the following hyperparameters were used:
a) Adam optimiser with initial learning rate 10⁻⁴
b) Step learning rate scheduler with λ=0.5
c) Total number of epochs is 200 epochs

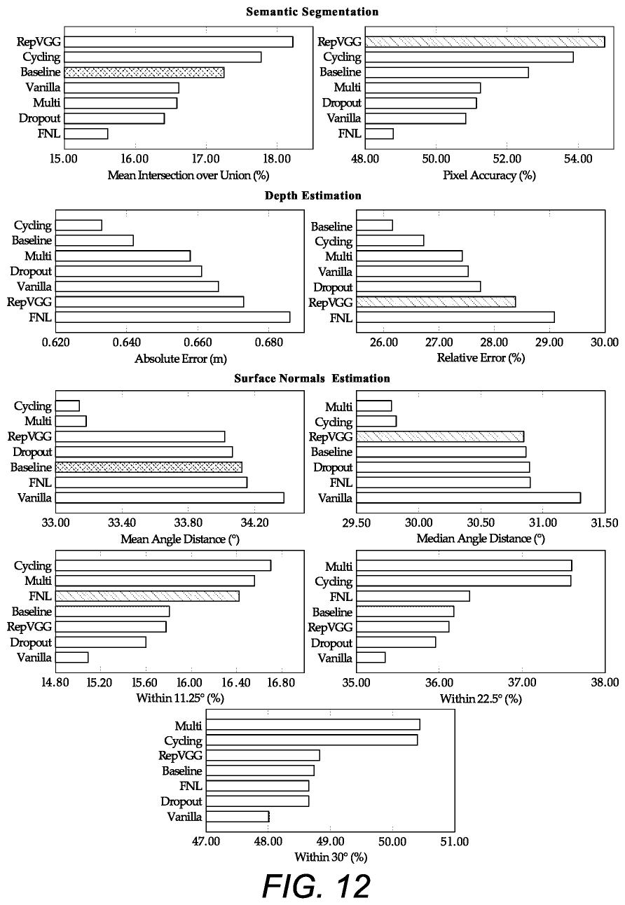

It can be seen that variants of the method in the present disclosure with either cycling or multi-task cycling have achieved the best performance for almost all metrics in depth estimation and surface normals estimation (except for relative error). This is also seen in FIG. 12 in which cycling and multi-task cycling are consistently one of the better performers.

Finally, the language used in the specification has been principally selected for readability and instructional purposes, and it may not have been selected to delineate or circumscribe the inventive subject matter. It is therefore intended that the scope of the present disclosure be limited not by this detailed description, but rather by any claims that issue on an application based here on. Accordingly, the embodiments of the present disclosure are intended to be illustrative, but not limiting, of the scope of the present disclosure, which is set forth in the following claims.

1. A computer-implemented method for automatically controlling a machine, the method comprising:
receiving data generated using at least one sensor of a machine;
performing one or more prediction tasks on the data using a neural network, wherein the neural network comprises at least one parameter tensor comprising at least one element, and the at least one parameter tensor was over-parameterized during training into a plurality of component tensors; and
controlling the machine based on results of the one or more prediction tasks.

2. The method of claim 1, wherein the plurality of component tensors comprise an identical number of elements as the at least one parameter tensor and were compressed by element-wise addition after training to generate the at least one parameter tensor.

3. The method of claim 1, wherein during training of the neural network, a subset of the plurality of component tensors is trained at each training epoch by updating elements of the subset of the plurality of component tensors while freezing elements of any other component tensors.

4. The method of claim 3, wherein at least one of:
the subset of the plurality of component tensors comprises one component tensor; or
the subset of the plurality of component tensors is selected randomly, wherein the selection is based on a probability of dropout associated with each of the plurality of component tensors.

5. The method of claim 1, wherein performing one or more prediction tasks on the data using a neural network comprises:
carrying out a plurality of forward passes on the neural network to generate a plurality of predictions for each prediction task, wherein a subset of elements of the at least one parameter tensor is dropped out during each forward pass; and
determining at least one of a mean, a variance or entropy for each of the prediction tasks based on the plurality of predictions generated for each prediction task.

6. The method of claim 1, wherein the one or more prediction tasks comprise one or more of: semantic segmentation, depth estimation, object detection, instance segmentation, lane detection, surface normal estimation, travelable area estimation, traffic sign recognition, natural language processing, classification, regression, emotion detection, intent detection, named entity recognition, or sentence boundary detection.

7. The method of claim 1,
wherein the machine corresponds to a mobile agent; and
wherein controlling the machine based on results of the one or more prediction tasks comprises, by at least one processor, at least one of steering the mobile agent, braking the mobile agent, parking the mobile agent, or providing an alert to an operator of the mobile agent or a third party.

8. A computing system for automatically controlling a machine, the computing system comprising one or more processors and memory storing one or more programs for execution by the one or more processors, the one or more programs including instructions for carrying out a computer-implemented method according to claim 1.

9. The computing system of claim 8, wherein the machine is a mobile agent, and the computing system is an embedded computing system of the mobile agent.

10. A machine or mobile agent comprising at least one sensor and the computing system of claim 8.

11. A computer-implemented method for generating a machine learned neural network that can perform one or more prediction tasks based on data of sensors of a machine for automatically controlling the machine, the computer-implemented method comprising:
training a learning neural network on a plurality of training datasets, the neural network comprising at least one over-parameterized parameter tensor, the at least one over-parameterized tensor comprising a plurality of component tensors; and
generating a machine learned neural network for performing one or more prediction tasks on a dataset, the machine learned neural network comprising at least one parameter tensor that is a combination of the trained plurality of component tensors;
embedding the machine learned neural network into a computing system for the machine such that the computing system performs the one or more prediction tasks on the sensor data of the machine and controls the machine based on results of the one or more prediction tasks.

12. The computer-implemented method of claim 11, wherein the trained plurality of component tensors comprise an identical number of elements as the at least one parameter tensor and are compressed by element-wise addition to generate the at least one parameter tensor.

13. The computer-implemented method of claim 11, wherein training the learning neural network comprises training a subset of the plurality of component tensors at each training epoch by updating elements of the subset of the plurality of components while freezing elements of any other component tensors.

14. The computer-implemented method of claim 13, wherein at least one of:
the subset of the plurality of component tensors comprises one component tensor; or
the subset of the plurality of component tensors is selected randomly, wherein the selection is based on a probability of dropout associated with each of the plurality of component tensors.

15. The computer-implemented method of claim 11, wherein the one or more prediction tasks comprise one or more of: semantic segmentation, depth estimation, object detection, instance segmentation, lane detection, surface normal estimation, travelable area estimation, traffic sign recognition, natural language processing, classification, regression, emotion detection, intent detection, named entity recognition, or sentence boundary detection.

16. The computer-implemented method of claim 11, wherein the machine corresponds to a mobile agent and controlling the machine based on results of the one or more prediction tasks comprises at least one of steering the mobile agent, braking the mobile agent, parking the mobile agent, or providing an alert to an operator of the mobile agent or a third party.

17. A data structure generated by the computer-implemented method of claim 11.

18. A data processing system comprising means for performing the steps of a computer-implemented method according to claim 1.

19. A computer program, a machine-readable storage medium, or a data carrier signal that comprises instructions, that upon execution on at least one of a data processing device or control unit comprising at least one processor, cause the at least one of the data processing device or control unit to perform the method according to claim 1.
